(19) United States
(12) Patent Application Publication
(10) Pub. No.: US 2011/0229844 A1
(43) Pub. Date: Sep. 22, 2011

(54) WATER PRESSURE TYPE WATER JET TEETH CLEANING DEVICE

(76) Inventor: Hak Man CHAN, Guangzhou (CN)

(21) Appl. No.: 12/884,184

(22) Filed: Sep. 17, 2010

(30) Foreign Application Priority Data
Nov. 4, 2009 (CN) 200910193671.3

(51) Int. Cl. A61C 17/02

(52) U.S. Cl. 433/80

(57) ABSTRACT

A water pressure type water jet teeth cleaning device, which has a nozzle with a curved tip including a hand held unit and a connecting tube. Attached to the connecting tub is a connector for connecting to the faucet. The water pressure type water jet teeth cleaning device of the present invention does not need a power supply to enhance safety, and is simple in structure and convenient to use.

### FIELD OF THE INVENTION

The present invention relates to a device. In particular, it relates to a water pressure type water jet teeth cleaning device which makes use of the pressure of tap water.

### BACKGROUND OF THE INVENTION

There are various ways of cleaning teeth, such as using dental floss or a toothbrush. When using a toothbrush to clean the teeth, the user usually squeezes a small amount of toothpaste onto the toothbrush first and then brushes the teeth. Afterward, the user rinses the mouth with clean water. Likewise, after using dental floss, one also needs to rinse his or her mouth with clean water. When rinsing the mouth, a person usually fills his or her mouth with a mouthful of water first and swishes water back and forth in the oral cavity, with the throat gargling the water, or by tilting the head back and forth to wash off the food debris loosened by the toothbrush or dental floss. However, it is difficult to wash off food debris adhered to the surfaces of the teeth with the cleaning force produced by such methods.

For that reason, a product referred to as a water jet teeth cleaner has been introduced to the market, which cleans teeth crevices and the surfaces of the teeth using a water jet, at a certain pressure and which can effectively clear the food debris adhered to the surfaces of the teeth and those lodged between the teeth. Such existing water jet teeth cleaning devices are usually comprised of a nozzle with a curved tip having a hand held unit, a micro water pump, a connecting tube and a reservoir, wherein the micro water pump is provided in the reservoir and a water inlet thereof pumps water from the reservoir, and a water outlet is connected to the nozzle with a curved tip having a hand held unit through the tube. Once the water pump is powered on, a stream of water having a set pressure is pumped out of the water pump and discharged from the nozzle, which can be used to clean teeth.

The disadvantage in such a product, however, is that the water pump requires household electricity or batteries, which brings about a series of problems. For example, one problem is that household electricity needs to be transformed to a safe voltage by a transformer, and another problem is that it requires safety measures for preventing creepage. Hence, the structure of the product is made so complicated and its price so high that it is difficult to become widely accepted.

### SUMMARY OF THE INVENTION

One object of the present invention is to solve the above mentioned technical problems by providing a water pressure type water jet teeth cleaning device which does not require a power supply and is safe, reliable, simple in structure and convenient to use.

The object can be achieved through the following technical solutions:

A water pressure type water jet teeth cleaning device, comprising a nozzle with a curved tip having a hand held unit and a tube connected to one end of the hand held unit, characterized in that the other end of the tube is a connector to be connected with a faucet.

The structure of the connector is: a double-layered tube having a tapered outer shape, the larger end of which is connected to one end of the tube, the inner tube of the double-layered tube is a rigid tube and the outer layer is made of elastic material, wherein the outer diameter of the smaller end of the double-layered tube is smaller than the aperture of the faucet spout and the outer diameter of the larger end is larger than the aperture of the faucet spout. Hence, it is convenient to insert the connector into the faucet spout, and the elastic material ensures a tight lock into the faucet spout, a good seal and an easy pull-out. Therefore, it can be applied to faucets having a relatively long spout.

The structure of the connector is: a cone shaped tube made of elastic material, the smaller end of which is connected to one end of the tube, the aperture of the smaller end of the cone shaped tube is smaller than the outer diameter of the faucet and the aperture of the larger end is larger than the outer diameter of the faucet. Hence, it is convenient to sheathe the faucet spout into the larger end of the connector of the cone shaped tube, and the use of elastic material can also ensure a good seal and an easy pull-out. Therefore, it can be applied to faucets having a relatively long spout.

The connector is comprised of a tube fitting and a fastener, wherein the tube fitting is a short tube, and two symmetrical cross pendulum shafts (of course it may also be one cross pendulum shaft whose two ends pass through and extend from the short tube) are provided on the body on the outer side of the short tube, one end of the short tube is connected to the tube, and the other end is provided with an annular rubber washer and is connected to the faucet spout for a better seal; the short tube is supported pendulately on the lower portion of the fastener by the cross pendulum shafts, and the lower portion of the fastener has a fork or a ring, and corresponding bearing holes are opened in the opposing inner sides of the two fork arms or the inner side of the ring to support the two cross pendulum shafts on the outer side of the short tube and the upper portion of the fastener is connected to the faucet.

The structure of the fastener is: a C-shaped clamp in the prior art, whereas the lower beam end thereof is bifurcated to form two fork arms, and corresponding bearing holes are opened in the opposing inner sides of the two fork arms to support the two cross pendulum shafts on the outer side of the short tube, a fastening screw is provided on the upper beam end of the C-shaped clamp. Hence, the C-shaped clamp can be clamped on a horizontally extending faucet by tightening the fastening screw.

The structure of the fastener is: a frame clamp, wherein a hole is opened in the lower beam of the frame clamp, and corresponding bearing holes are opened in the inner side of the hole to support the two cross pendulum shafts on the outer sides of the short tube, a fastening screw is provided on the upper beam of the frame clamp. This embodiment can also be clamped on a horizontally extending faucet.

The structure of the fastener is: a clamp formed by hinging two screws from within, a strong fastening torsion spring is provided on the hinge shaft, the front portion of the hinge shaft is a clip arm, one end of which is bifurcated to form two fork arms, corresponding bearing holes are opened in the opposing inner sides of the two fork arms to support the two cross pendulum shafts on the outer side of the short tube. This embodiment can be applied to horizontally extending faucets by opening the clamp and clamping it on the faucet spout.

The structure of the fastener is: a short tube, at least three fastening bolts are evenly distributed on the same circumference in the wall of the short tube and pass through the wall. During use, the faucet is sheathed into the fastener of the short tube, and the short tube can be fastened on the faucet by tightening the fastening bolts.

The fastener of the short tube and the tube fitting are integrally produced.

The structure of the fastener is: a frame clamp, wherein a hole is opened in the lower beam of the frame clamp, and corresponding bearing holes are opened in the inner side of the hole to support the two cross pendulum shafts on the outer side of the short tube; a press plate is articulated to the upper beam of the frame clamp through an articulated shaft; wherein said press plate comprises a handle portion and a press portion, turning the handle portion such that the press portion presses the faucet downward to fasten the upper end of the short tube on the faucet, or removing the pressure such that the faucet moves upwards to separate the faucet from the short tube; a transparent window for observing the interior is provided on a side of the frame clamp.

A rubber sheet is provided between the press portion of the press plate and the faucet, at least two springs for supporting the rubber sheet are provided on the lower beam of the frame clamp, and the upper ends of the springs are pressed firmly against the bottom of the rubber sheet. The rubber sheet increases the friction between the press plate and the faucet. Turning the press plate will not cause any relative movement between the press plate and the faucet. Furthermore, the thickness of the rubber sheet can be adjusted according to the distance between the press plate and the faucet such that the fastener as a whole has better compatibility.

An elastic rubber washer is provided between the upper end of the short tube of the tube fitting and the faucet. The addition of the elastic rubber washer can provide a better seal at the connecting part between the short tube and the faucet.

A connection pipe is provided between the short tube of the tube fitting and the tube, and the lower end of the connection pipe is connected to the water inlet end of the tube, wherein the outer diameter of the lower end of the connection pipe is adapted to the inner diameter of the water inlet end of the tube; the inner diameter of the upper end of the connection pipe is adapted to the outer diameter of the lower end of the short tube, a ring-shaped rib (or O-ring) is provided on the outer side of the lower end of the short tube, and a corresponding groove is provided in the inner side of the upper end of the connection pipe, the ring-shaped rib is engaged in the groove to fix the lower end of the short tube on the upper end of the connection pipe

A switch may be further provided, and the male thread is lathed on the water inlet, which corresponds to the female thread in the faucet spout, wherein a water outlet is provided under the end of a horizontally extending short tube. Hence, the connector comprised of a tube fitting and a fastener can be applied.

A push switch is provided on the hand held unit of the nozzle with a curved tip having a hand held unit, and a wave wheel is provided inside the hand held unit. A water stream is expelled in a pulsed form by opening and closing of the push switch.

transparent glass window is provided on the hand held unit of the nozzle with a curved tip having a hand held unit such that the inner chamber is visible. Hence, the user can see whether or not there is scale in it in order to facilitate replacement of the teeth cleaning device.

Advantageous effects: the present water pressure type water jet teeth cleaning device does not need a power supply such that safety can be ensured and it is simple in structure and convenient to use.

### BRIEF DESCRIPTION OF THE DRAWINGS

The present invention will be further explained in detail in conjunction with the accompanying drawings and embodiments.

FIG. 1 is a schematic view of the composition structure of Embodiment 1 of the present invention.

FIG. 2 is a schematic sectional view of the tube fitting of the tube in Embodiment 1.

FIG. 3 is a view of FIG. 1 along A-direction.

FIG. 4 is a schematic view of the connection between Embodiment 1 and a faucet.

FIG. 5 is a schematic sectional view of the connector in Embodiment 2.

FIG. 6 is a schematic sectional view of the connector in Embodiment 3.

FIG. 7 is a schematic view of the composition structure of the connector of the C-shaped clamp in Embodiment 4.

FIG. 8 is a view of FIG. 7 along B-direction.

FIG. 9 is a schematic top view of the lower beam of the connector of the C-shaped clamp in Embodiment 5.

FIG. 10 is a schematic view of the connector in Embodiment 6.

FIG. 11 is a schematic top view of the lower beam in Embodiment 6.

FIG. 12 is a schematic view of the connector in Embodiment 7.

FIG. 13 is a schematic top view of FIG. 12.

FIG. 14 is a schematic sectional view of FIG. 12 along C-C direction.

FIG. 15 is a schematic view of the switch.

FIG. 16 shows the structure of Embodiment 8 of the present invention.

FIGS. 17 and 18 shows the structure of Embodiment 8 of the present invention, with the tube attached to and detached from the connector, respectively.

FIG. 19 is a cross section view of the press portion of the press plate in an embodiment of the present invention.

FIG. 20. is a cross section view of the held unit of the nozzle in an embodiment of the present invention.

In the drawings: 1—hand held unit, 2—nozzle with a curved tip, 3—tube, 5—double-layered tapered tube, 6—cone tube, 7—tube fitting, 8—fastener, 9—cross pendulum shaft, 10—annular rubber washer, 11—C-shaped clamp, 12—frame clamp, 13—fastening screw, 14—clamp, 15—torsion spring, 16—short tube, 17—fastening bolt, 18—switch, 19—transparent glass window, 20—faucet, 21—press plate, 22—spring, 23—connection pipe, 24—transparent window on the fastener, 25—wave wheel, 26—push switch, 27—rubber sheet and 28—elastic rubber washer.

### DETAILED DESCRIPTION OF PARTICULAR EMBODIMENTS OF THE INVENTION

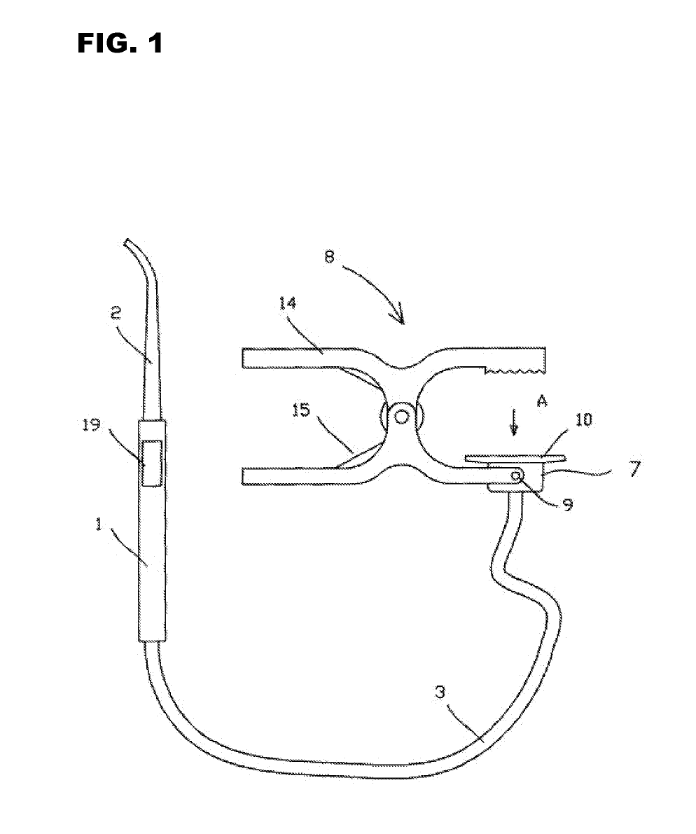

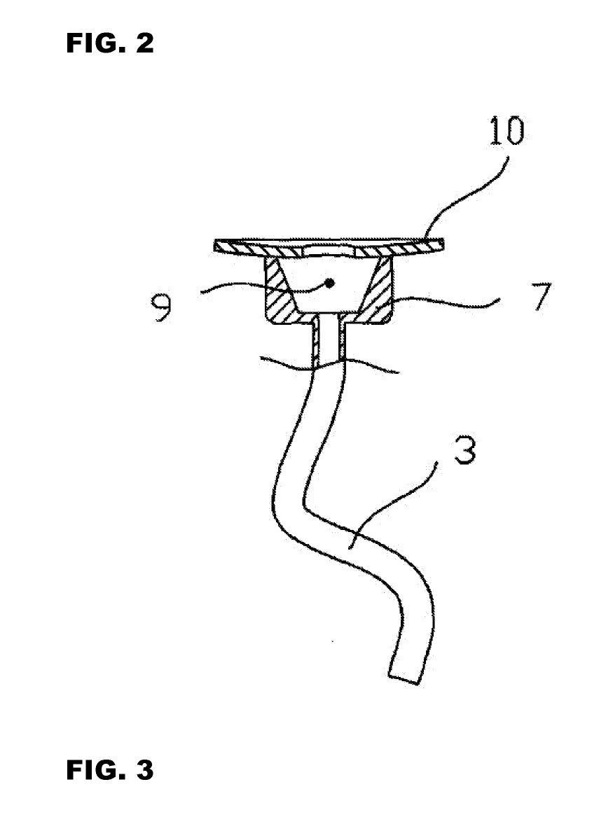

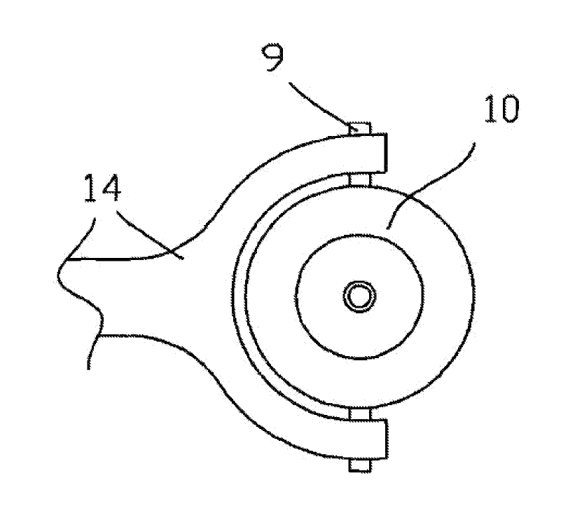

As shown in FIG. 1 through FIG. 4, Embodiment 1 of the water pressure type water jet teeth cleaning device of the present invention comprises a nozzle 2 with a curved tip having a hand held unit 1 and a tube 3 connected to one end of the hand held unit, and the other end of the tube is a connector to be connected with a faucet.

The connector of this embodiment is comprised of a tube fitting 7 and a fastener 8, wherein the tube fitting 7 is a short tube, one end of which is connected to tube 3, and the other end is provided with an annular rubber washer 10. The annular rubber washer 10 is connected to the faucet spout for a better seal to prevent water leakage; and two symmetrical cross pendulum shafts 9 (of course it may also be one cross pendulum shaft whose two ends pass through and extend from the short tube) are provided on the same circumference of the tube body on the outer side of the short tube, and the short tube is supported pendulately on the lower portion of the fastener 8 by the cross pendulum shafts 9.

The structure of the fastener 8 is: a clamp 14 formed by hinging two screws from within, a strong fastening torsion spring 15 is provided on the hinge shaft, the front portion of the hinge shaft is a clip arm, one end of which is bifurcated to form two fork arms, corresponding bearing holes are opened in the opposing inner sides of the two fork arms to support the two cross pendulum shafts 9 on the outer side of the short tube.

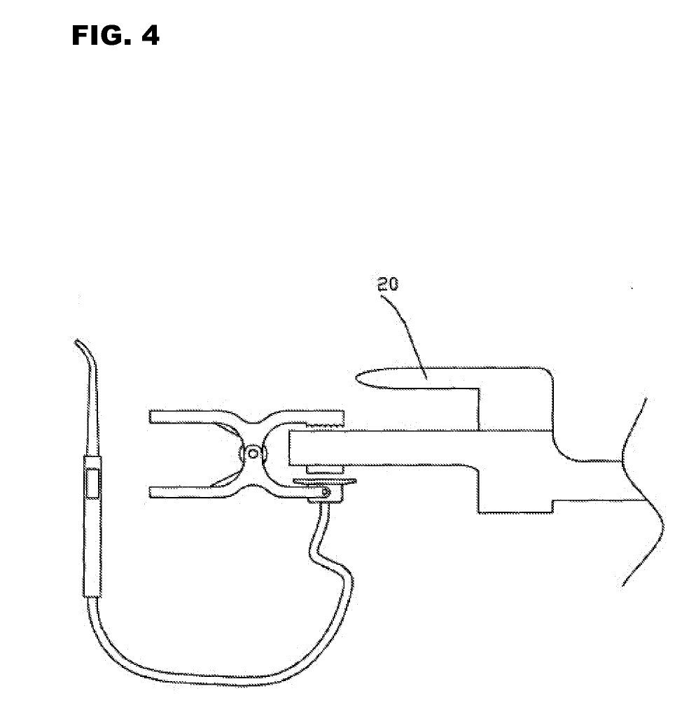

This embodiment can be applied to horizontally extending faucets, see FIG. 4.

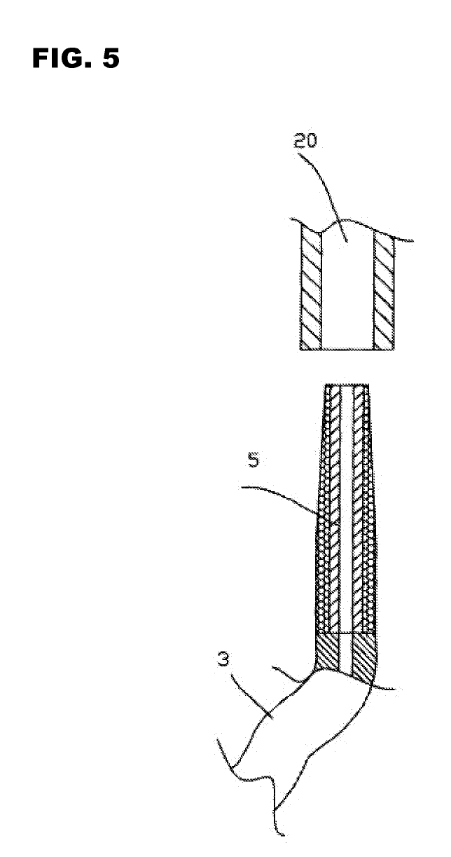

FIG. 5 shows Embodiment 2 of the present invention, which also comprises a nozzle 2 with a curved tip having a hand held unit 1 and a tube 3 connected to one end of the hand held unit, and the other end of the tube is a connector to be connected with a faucet.

The structure of the connector of this embodiment is: a double-layered tube 5 having a tapered outer shape, the larger end of which is connected to one end of the tube, the inner tube of the double-layered tube is a rigid tube and the outer layer is made of elastic materials such as rubber, the outer diameter of the smaller end of the double-layered tube having a tapered outer shape is smaller than the aperture of the faucet spout and the outer diameter of the larger end is larger than the aperture of the faucet spout.

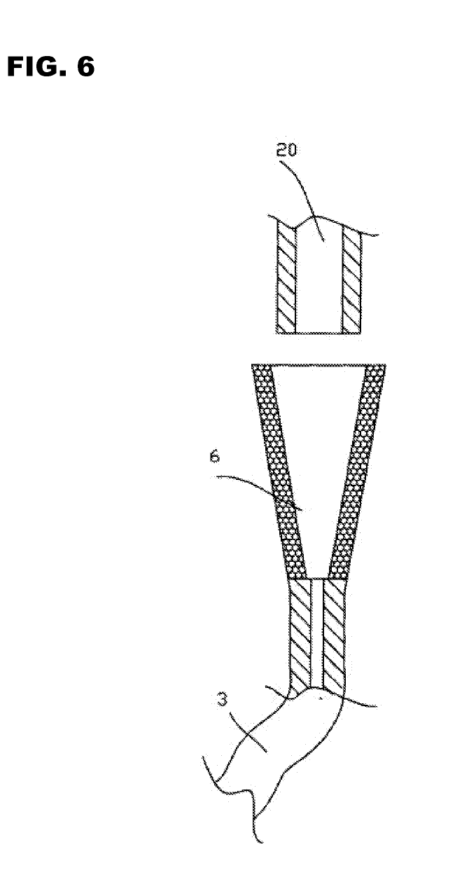

FIG. 6 shows Embodiment 3 of the present invention, which differs from Embodiment 2 in that the structure of the connector is: a cone tube 6 made of elastic materials such as rubber, the smaller end of which is connected to one end of the tube, the aperture of the smaller end of the cone tube is smaller than the outer diameter of the faucet and the aperture of the larger end is larger than the outer diameter of the faucet.

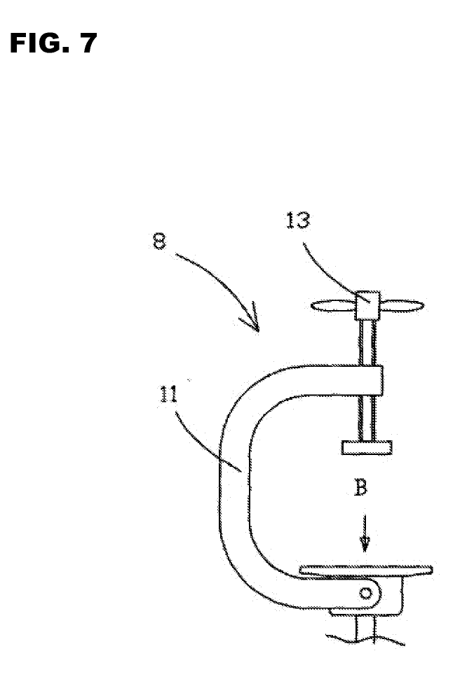

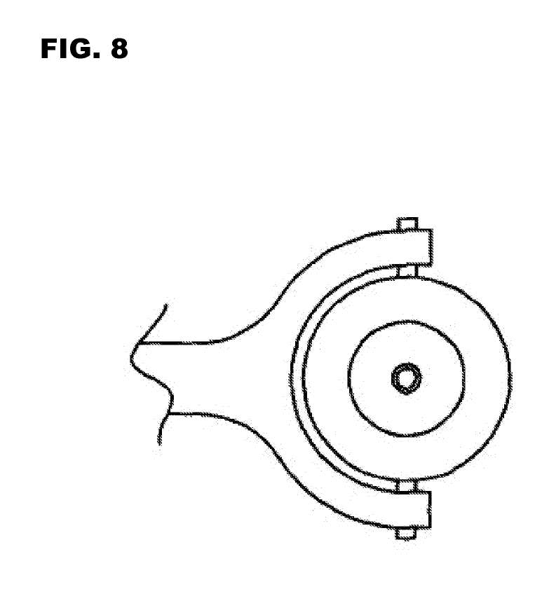

FIG. 7 and FIG. 8 show Embodiment 4 of the present invention, which also comprises a nozzle 2 with a curved tip having a hand held unit 1 and a tube 3 connected to one end of the hand held unit, and the other end of the tube is a connector to be connected with a faucet.

Like Embodiment 1, the connector of this embodiment is comprised of a tube fitting 7 and a fastener 8, wherein the tube fitting 7 is a short tube, one end of which is connected to the tube 3, and the other end is provided with an annular rubber washer 10, which is connected to the faucet spout for a better seal.

The structure of the fastener 8 in this embodiment is: a C-shaped clamp 11 in the prior art, whereas the lower beam end thereof is bifurcated to form two fork arms, and corresponding bearing holes are opened in the opposing inner sides of the two fork arms to support the two cross pendulum shafts 9 on the outer side of the short tube, a fastening screw 13 is provided on the upper beam end of the C-shaped clamp.

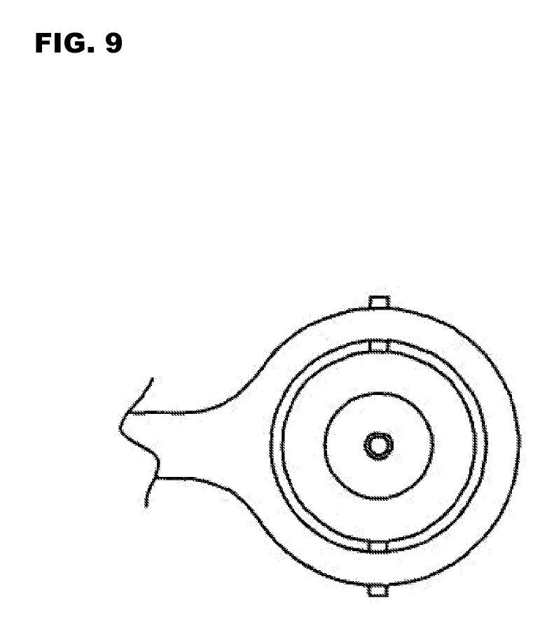

Embodiment 5 differs from Embodiment 4 only in that the front end of the lower beam forms a ring instead of a fork, wherein corresponding bearing holes are opened in the inner side of the ring to support the two cross pendulum shafts 9 on the outer side of the short tube, see FIG. 9.

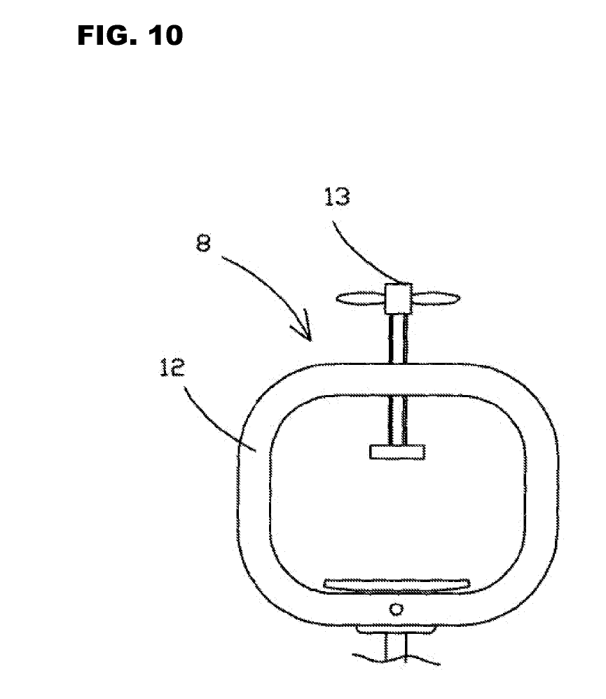

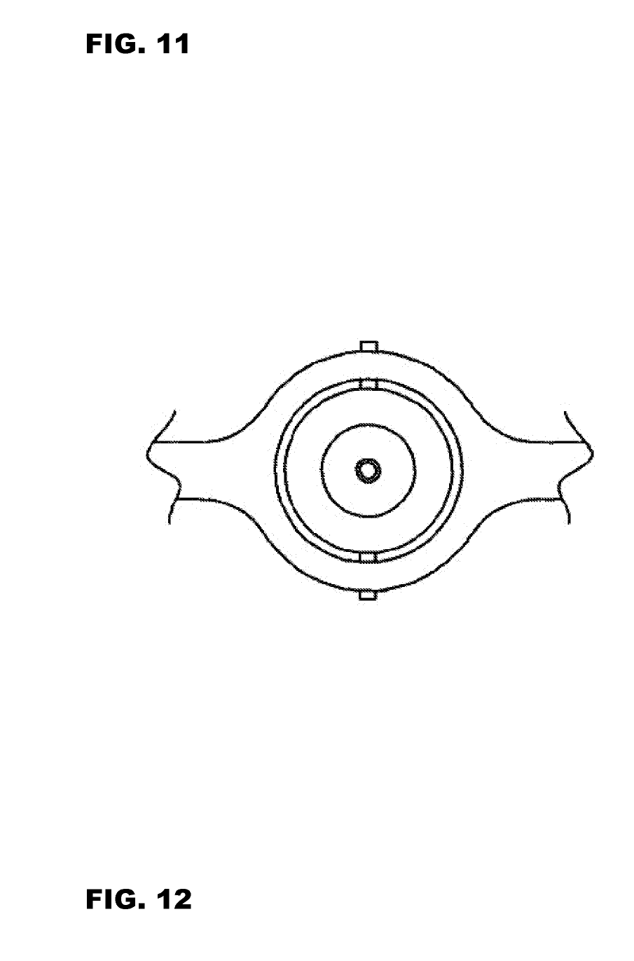

FIG. 10 and FIG. 11 show Embodiment 6 of the present invention, which differs from Embodiment 5 in that the structure of the fastener is a frame clamp 12, and a hole is opened in the lower beam of the frame clamp, and corresponding bearing holes are opened in the inner side of the hole to support the two pendulum shafts 9 on the outer sides of the short tube, and a fastening screw 13 is provided on the upper beam of the frame clamp.

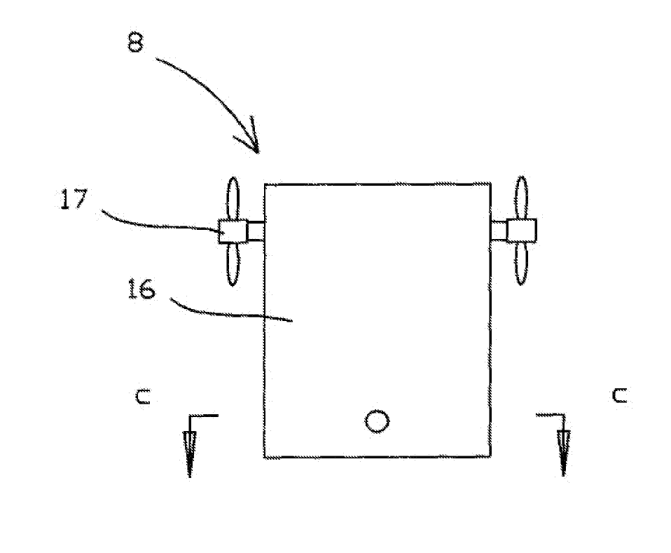

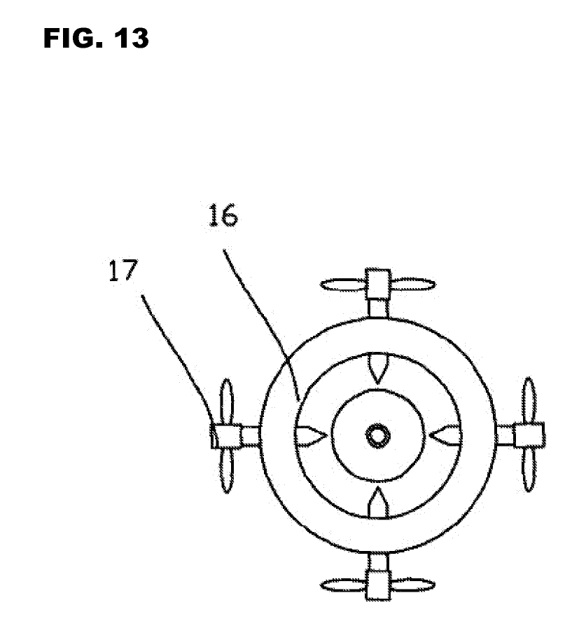

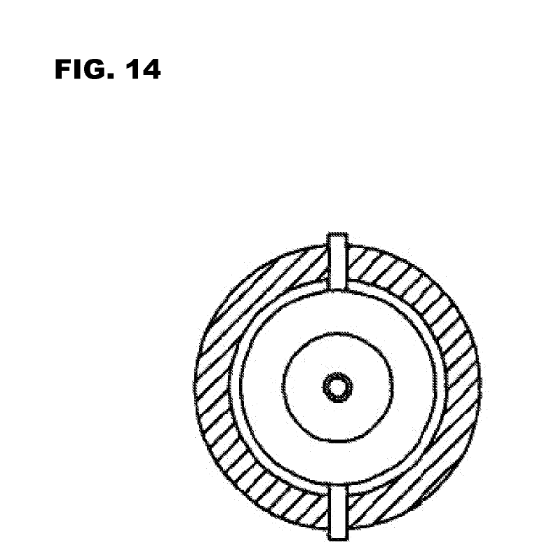

FIG. 12 through FIG. 14 show Embodiment 7 of the present invention, which differs from Embodiment 4 in that the structure of the fastener is a short tube 16, four fastening bolts 17 are evenly distributed on the same circumference in the wall of the short tube and pass through the wall. In fact, the fastener of the short tube and the tube fitting in this embodiment are integrally produced.

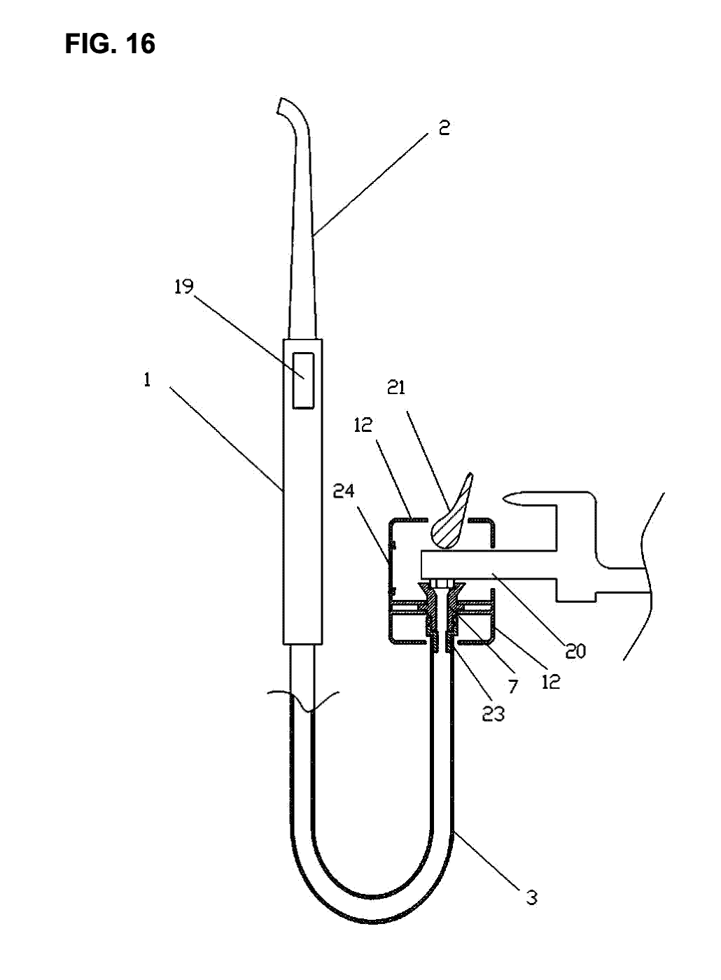

FIG. 16 shows Embodiment 8 of the present invention, and it differs from Embodiment 6 in that the structure of the fastener is: a frame clamp 12, wherein a hole is opened in the lower beam of the frame clamp, and corresponding bearing holes are opened in the inner side of the hole to support the two cross pendulum shafts 9 on the outer side of the short tube; a press plate 21 is articulated to the upper beam of the frame clamp through an articulated shaft; wherein said press plate 21 comprises a handle portion and a press portion, as shown in FIG. 16, the cross section of the press portion is an oval. Turning the handle portion of the press plate 21 such that the press portion presses the faucet 20 downward to fasten the upper end of the short tube of the tube fitting 7 on the faucet 20, or removing the pressure such that the faucet 20 moves upward to separate the faucet 20 from the short tube; a transparent window 24 for observing the interior is provided on the front of the frame clamp. A connection pipe 23 is provided between the short tube of the tube fitting 7 and the tube, and the lower end of the connection pipe 23 is connected to the water inlet end of the tube 3, wherein the outer diameter of the lower end of the connection pipe 23 is adapted to the inner diameter of the water inlet end of the tube 3; the inner diameter of the upper end of the connection pipe 23 is adapted to the outer diameter of the lower end of the short tube of the tube fitting 7, a ring-shaped rib is provided on the outer side of the lower end of the short tube of the tube fitting 7, and a corresponding groove is provided in the inner side of the upper end of the connection pipe 23, the ring-shaped rib is engaged in the groove to fix the lower end of the short tube of the tube fitting 7 on the upper end of the connection pipe.

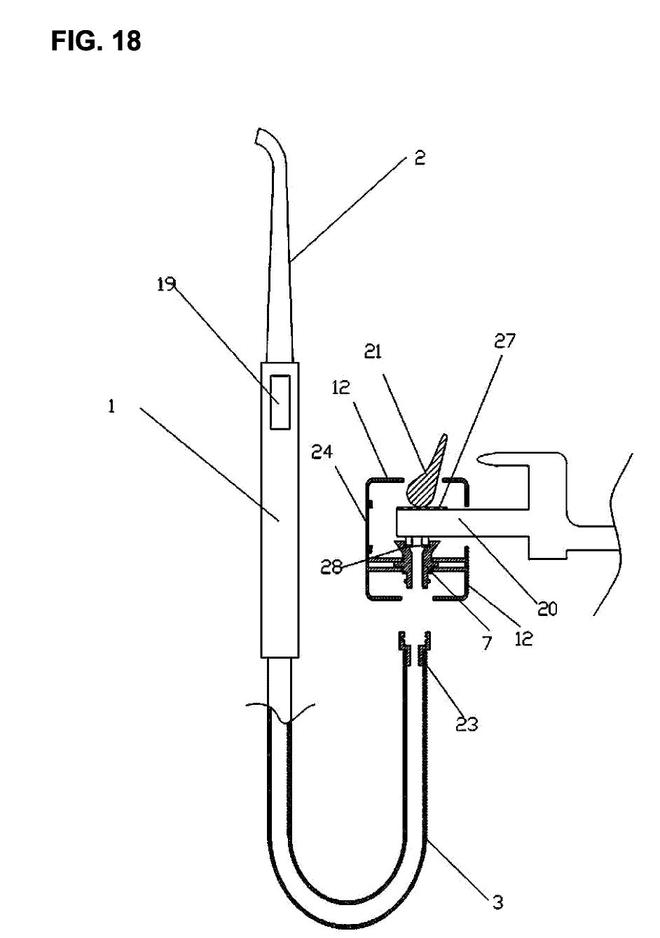

As shown in FIG. 19, the cross section of the press portion of the press plate 21 may also be a sector, and the distance between the center of the bearing hole in the press plate and the two end points of the arc of the sector is greater than the distance between the center of the bearing hole in the press plate and the midpoint of the arc.

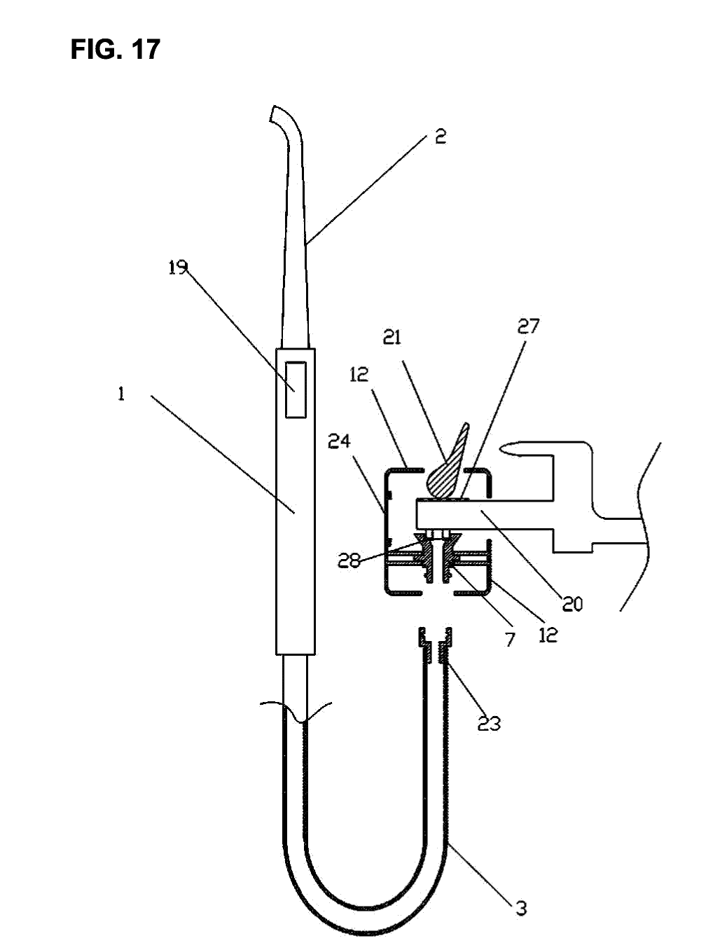

FIGS. 17 and 18 show Embodiment 9 of the present invention, and it differs from Embodiment 8 in that a rubber sheet 27 is provided between the press portion of the press plate and the faucet 20, and two springs are provided on the lower beam of the frame clamp, and the upper ends of the two springs 22 are pressed firmly against the bottom of the rubber sheet 27 so as to support the rubber sheet 27. An elastic rubber washer 28 is also provided between the upper end of the short tube of the tube fitting 7 and the faucet 20. The addition of the elastic rubber washer can provide a better seal at the connecting part between upper end of the short tube of the tube fitting 7 and the faucet 20.

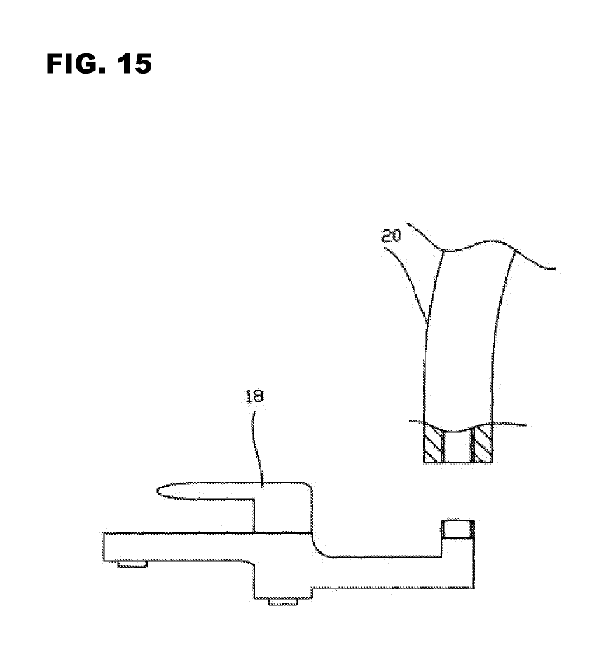

Furthermore, in order to adapt to faucets with shower heads, the shower heads are screwed by the thread in the faucet spout by means of a thread, see FIG. 15. On the basis of the present invention, a switch 18 can be further provided, and male thread is lathed on the water inlet, which corresponds to the female thread in the faucet spout, wherein a water outlet is provided under the end of a horizontally extending short tube. Hence, the connector formed by a tube fitting and a fastener can be applied.

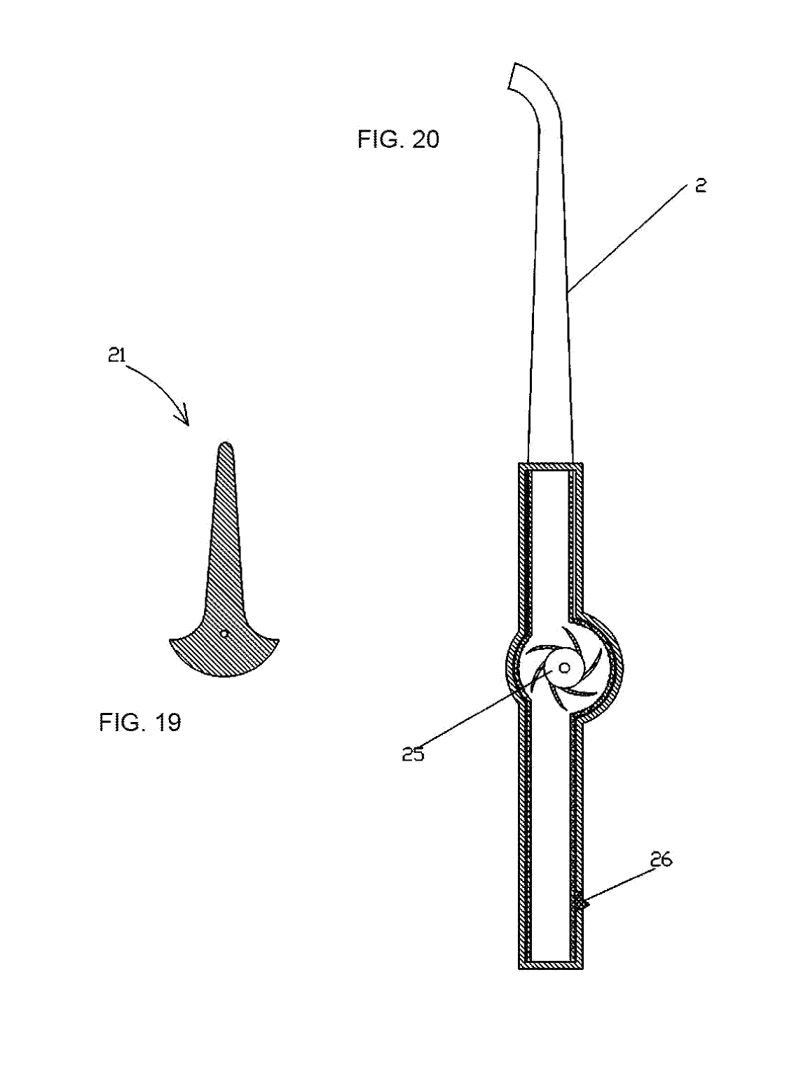

As shown in FIG. 20, a push switch 26 is provided on the hand held unit 1 of the nozzle with a curved tip having a hand held unit, and a wave wheel 25 is provided inside the hand held unit. A water stream is expelled in a pulsed form by opening and closing of the push switch 26.

Still further, in all the above embodiments, a transparent glass window 19 can be provided on the hand held unit of the nozzle with a curved tip, which makes the inner chamber visible. Hence, the user can see whether there is scale in it or not to facilitate replacement of the teeth cleaning device.

The above implementation steps are only to describe the technical theory and features of this invention and to make the technology of the invention easier to be understood and carried out. However, the protection scope of the invention is not limited to above embodiments; that is all methods which make some changes or modifications according to the essence of this invention belong to the protection scope of this invention

What is claimed is:

1. A water pressure type water jet teeth cleaning device, comprising a nozzle with a curved tip having a hand held unit and a tube connected to an end of the hand held unit, wherein the other end of the tube is a connector to be connected with a faucet, characterized in that the structure of the connector is a double-layered tube having a tapered outer shape, the larger end of which is connected to an end of the tube, the inner tube of the double-layered tube is a rigid tube and the outer layer is made of elastic material, wherein the outer diameter of the smaller end of the double-layered tube having a tapered outer shape is smaller than the aperture of the faucet spout and the outer diameter of the larger end is larger than the aperture of the faucet spout.

2. A water pressure type water jet teeth cleaning device, comprising a nozzle with a curved tip having a hand held unit and a tube connected to an end of the hand held unit, wherein the other end of the tube is a connector to be connected with a faucet, characterized in that the connector is comprised of a tube fitting and a fastener, wherein the tube fitting is a short tube, and two symmetrical cross pendulum shafts or a cross pendulum shaft whose two ends pass through and extend from the short tube is/are provided on the outer side of the body of the short tube, one end of the short tube is connected to the tube, and the other end is provided with an annular rubber washer which is connected to the faucet spout; the short tube is supported pendulately on the lower portion of the fastener by the cross pendulum shafts, and the lower portion of the fastener has a fork or a ring, and corresponding bearing holes are opened in the opposing inner sides of the two fork arms or the inner side of the ring to support the two cross pendulum shafts on the outer side of the short tube and the upper portion of the fastener is connected to the faucet.

3. The water pressure type water jet teeth cleaning device according to claim 2, characterized in that the structure of the fastener is: a C-shaped clamp in the prior art, whereas the lower beam end thereof is bifurcated to form two fork arms, and corresponding bearing holes are opened in the opposing inner sides of the two fork arms to support the two cross pendulum shafts on the outer side of the short tube, a fastening screw is provided on the upper beam end of the C-shaped clamp.

4. The water pressure type water jet teeth cleaning device according to claim 2, characterized in that the structure of the fastener is: a frame clamp, wherein a hole is opened in the lower beam of the frame clamp, and corresponding bearing holes are opened in the inner side of the hole to support the two cross pendulum shafts on the outer side of the short tube, a fastening screw is provided on the upper beam of the frame clamp.

5. The water pressure type water jet teeth cleaning device according to claim 2, characterized in that the structure of the fastener is: a clamp formed by hinging two screws from within, a strong fastening torsion spring is provided on the hinge shaft, the front portion of the hinge shaft is a clip arm, one end of which is bifurcated to form two fork arms, and corresponding bearing holes are opened in the opposing inner sides of the two fork arms to support the two cross pendulum shafts on the outer side of the short tube.

6. The water pressure type water jet teeth cleaning device according to claim 2, characterized in that the structure of the fastener is: a short tube, at least three fastening bolts are evenly distributed on the same circumference in the wall of the short tube and pass through the wall.

7. The water pressure type water jet teeth cleaning device according to claim 2, characterized in that the structure of the fastener is: a frame clamp, wherein a hole is opened in the lower beam of the frame clamp, and corresponding bearing holes are opened in the inner side of the hole to support the two cross pendulum shafts on the outer side of the short tube; a press plate is articulated to the upper beam of the frame clamp through an articulated shaft; wherein said press plate comprises a handle portion and a press portion, turning the handle portion such that the press portion presses the faucet downward to fasten the upper end of the short tube on the faucet, or removing the pressure such that the faucet moves upward to separate the faucet from the short tube; a transparent window for observing the interior is provided on a side of the frame clamp.

8. The water pressure type water jet teeth cleaning device according to claim 7, characterized in that a rubber sheet is provided between the press portion of the press plate and the faucet, at least two springs for supporting the rubber sheet are provided on the lower beam of the frame clamp, and the upper ends of the springs are pressed firmly against the bottom of the rubber sheet.

9. The water pressure type water jet teeth cleaning device according to claims 2 through 8, characterized in that an elastic rubber washer is provided between the upper end of the short tube of the tube fitting and the faucet.

10. The water pressure type water jet teeth cleaning device according to claim 9, characterized in that a connection pipe is provided between the short tube of the tube fitting and the tube, and the lower end of the connection pipe is connected to the water inlet end of the tube, wherein the outer diameter of the lower end of the connection pipe is adapted to the inner diameter of the water inlet end of the tube; the inner diameter of the upper end of the connection pipe is adapted to the outer diameter of the lower end of the short tube, a ring-shaped rib is provided on the outer side of the lower end of the short tube, and a corresponding groove is provided in the inner side of the upper end of the connection pipe, the ring-shaped rib is engaged in the groove to fix the lower end of the short tube on the upper end of the connection pipe.

11. The water pressure type water jet teeth cleaning device according to claim 10, characterized in that a switch may be further provided, and male thread is lathed on the water inlet, which corresponds to the thread in the faucet spout, wherein a water outlet is provided under the end of a horizontally extending short tube.

12. The water pressure type water jet teeth cleaning device according to claim 11, characterized in that a push switch is provided on the hand held unit of the nozzle with a curved tip having a hand held unit, and a wave wheel is provided inside the hand held unit, and a water stream is expelled in a pulsed form by opening and closing of the push switch.

13. The water pressure type water jet teeth cleaning device according to claim 12, characterized in that a transparent glass window is provided on the hand held unit of the nozzle with a curved tip having a hand held unit such that the inner chamber is visible.
